(19) United States
(12) Patent Application Publication
(10) Pub. No.: US 2015/0283500 A1
(43) Pub. Date: Oct. 8, 2015

(54) Solution-Based Mercury Capture

(71) Applicant: NOVINDA CORPORATION, Denver, CO (US)

(72) Inventors: James Robert Butz, Lakewood, CO (US); Michael A. Lucarelli, McMurray, PA (US)

(73) Assignee: NOVINDA CORP., Denver, CO (US)

(21) Appl. No.: 14/435,193

(22) PCT Filed: Oct. 9, 2013
(86) PCT No.: PCT/US13/64028

§ 371 Date: Apr. 13, 2015

Related U.S. Application Data
(60) Provisional application No. 61/714,378, filed on Oct. 16, 2012.
(60) Provisional application No. 61/714,370, filed on Oct. 16, 2012.
(60) Provisional application No. 61/714,362, filed on Oct. 16, 2012.

(51) Int. Cl. B01D 53/64; B01D 53/79; B01D 53/81; F23J 15/02

(52) U.S. Cl. CPC B01D 53/64; F23J 15/02; B01D 53/79; B01D 53/81; B01D 2253/106; B01D 2253/104; B01D 2253/102; B01D 2253/1126; B01D 2257/602

(57) ABSTRACT

A mercury capture system and method that includes the equipment for and the production of a mercury-sorbent metal sulfide in a flue gas conduit of a coal fired power plant. The system can include transition metal salt solution injection and sulfur solution injection apparati that can introduce transition metal salt solution and sulfur solution droplets (individually or as a co-injection) into the flue gas stream. The method can include the introduction (individually or as a co-injection) of a copper salt, an iron salt, and a sulfur compound into the flue gas stream, wherein the mercury-sorbent metal sulfide can be manufactured and reacted with mercury in the flue gas.

### CROSS-REFERENCE TO RELATED APPLICATIONS

This disclosure claims the benefit of priority to U.S. Provisional Application 61/714,378 filed Oct. 16, 2012; 61/714,370 filed Oct. 16, 2012; and 61/714,362 filed Oct. 16, 2012, the disclosures of which are incorporated herein in their entireties.

### FIELD OF THE INVENTION

This invention is directed to the capture of mercury from the flue gas of a coal fired power plant, compositions for flue gas treatment, and processes for making and using the compositions. In particular, the invention relates to a high capacity sorbent for removal of mercury from flue gas and processes and systems for making and using the sorbent.

### BACKGROUND

Emissions of mercury from coal-fired and oil-fired power plants have become a major environmental concern. Mercury (Hg) is a potent neurotoxin that affects human health at very low concentrations. The largest source of mercury emission in the United States is coal-fired electric power plants. These coal-fired power plants account for between one-third and one-half of total mercury emissions in the United States.

The mercury emission is predominantly through the flue gas (exhaust gas) ejected from the burning coal. There are three basic forms of Hg in the flue gas: elemental Hg; oxidized Hg; and particle-bound mercury.

Currently, the most common method for mercury emissions reduction from coal-fired and oil-fired power plants is the injection of powdered activated carbon into the flue stream. The activated carbon provides a high surface area material for the adsorption of the mercury and the agglomeration of the particle bound mercury. The disadvantage of adding activated carbon into the flue stream is the retention of the activated carbon in the fly ash waste stream. Fly ash from coal-fired power plants if often added to concrete, where the presence of the activated carbon adversely affects the performance.

Another method for reducing Hg emissions is through the addition of powdered silicate-based reagents that react with mercury to chem-adsorb the elemental Hg and oxidized Hg. These silicate-based reagents are commonly manufactured by the formation of copper sulfides in the presence of a silicate-support (e.g. clay). U.S. Pat. Nos. 6,719,828, 7,048,781, and 7,288,499 teach metal sulfides carried by silicates and the use of these silicate-based reagents for the removal of mercury from flue gas. U.S. Pat. Nos. 7,575,629 and 7,704,920 and U.S. Pat. Ser. Nos. 12/485,561 and 13/017,539 teach variations on the preparation of these silicate-based reagents.

There is still an ongoing need to provide improved pollution control and pollution control sorbents. In this regard, simple and environmentally friendly methods that effectively remove mercury from flue gas and are capable of being implemented in existing coal fired power plants are needed.

### SUMMARY

In one embodiment, a mercury capture system includes a flue gas conduit having an upstream portion and a downstream portion and positioned to carry a gas stream produced by a coal-fired boiler; a metal solution injection apparatus, that includes a conduit and a nozzle, adapted to produce droplets of a transition metal salt solution and introduce them into the gas stream; a sulfur injection apparatus, that includes a conduit and a nozzle, adapted to produce droplets of a sulfur solution and introduce them into the flue gas stream; and a particulate collector.

In another embodiment, a mercury capture system includes a flue gas conduit having an upstream portion and a downstream portion and positioned to carry a flue gas stream produced by a coal-fired boiler; a co-injection nozzle configured to produce droplets of an admixture of a transition metal salt solution and a sulfur solution and to introduce the droplets into the flue gas stream, the co-injection nozzle fluidly connected to at least one solution conduit; and a particulate collector.

In still another embodiment, a process of capturing and removing mercury from a flue gas includes injecting into a flue gas generated by the combustion of coal in a coal-fired boiler either: a plurality of droplets of a transition metal cation solution that includes a transition metal salt and a plurality of droplets of a sulfur solution that includes a sulfur compound, or a plurality of droplets of an admixture of the transition metal salt solution and the sulfur solution; forming a mercury-sorbent sulfide from the transition metal salt and the sulfur compound; reacting the mercury-sorbent sulfide with mercury to form a mercury-metal-sulfide particulate; and collecting the mercury-metal-sulfide particulate from the flue gas.

In still yet another embodiment, a process of capturing and removing mercury from a flue gas includes injecting into a flue gas generated by the combustion of coal in a coal-fired boiler a plurality of droplets of a solution that carries a mercury-sorbent sulfide and a solvent; reacting the mercury-sorbent sulfide with mercury to form a mercury-metal-sulfide particulate; and collecting the mercury-metal-sulfide particulate from the flue gas.

### BRIEF DESCRIPTION OF THE FIGURES

For a more complete understanding of the disclosure, reference should be made to the following detailed description and accompanying drawing figures wherein:

FIG. 1 is a schematic of a mercury capture system having separate transition metal salt and sulfur injection nozzles; and

FIG. 2 is a schematic of a mercury capture system having a co-injection nozzle.

While specific embodiments are illustrated in the figures, with the understanding that the disclosure is intended to be descriptive of the invention, these embodiments are not intended to limit the invention described and illustrated herein.

### DETAILED DESCRIPTION

The herein described system and process are directed to the injection of liquid mercury capture components or injection of liquid precursors to mercury capture components. Specifically, the capture of elemental and/or ionic mercury from the flue gas generated by the combustion of mercury containing coal. Preferably, the system and process provide a mercury capture (wt % Hg captured/total wt % Hg) of at least 50%, at least 60%, at least 70%, at least 80%, or at least 90%. More preferably, the system and process provide the capture and sequestration of mercury, even more preferably the system and process provide the capture and sequestration of mercury intermixed with fly ash without affecting the use of the fly ash in concrete. Preferably, the mercury is sequestered as a mercuric sulfide, for example, cinnabar or metacinnabar.

Herein some of the employed terms have similar or overlapping meanings; for the purpose of clarification the following terms are explained even though they are well understood by those of ordinary skill in the art. Herein, sorbent refers to a material that can either absorb or adsorb a chemical component. Preferably, the sorbent is a solid phase material and has ion-exchangeable sites, a micro or macro porous structure, and/or an ionic charge. The term reacting includes any chemical process. Exemplary processes that are incorporated into the meaning of reacting include absorbing, adsorbing, oxidizing, reducing, and cation-anion exchange. The term transition metal salt means a materials that includes at least one transition metal that has positive oxidation state (a transition metal cation) and includes an anion; notably, the level of ionic or covalent nature of the interaction between the cation(s) and anion(s) is not important but for the fact that the salt can undergo displacement reactions. Aspects of the system (and apparatus employed in the herein disclosed process) may refer to a metal solution injection apparatus or a sulfur injection apparatus, these terms distinguish between the injection of a transition metal salt solution (metal solution injection apparatus) and a sulfur/sulfide solution (sulfur injection apparatus) and do not refer, unless specifically described below, the direct injection of an elemental form of a metal or sulfur.

The herein described system and process are contemplated in a variety of embodiments, for example, a system that includes separate injection of cation and anion reagents, a process of employing the system that includes separate injection of cation and anion reagents for the formation of a mercury capture agent and capture of mercury, a system that includes the injection of an admixture of cation and anion reagents or a system that includes the injection of a slurry formed by the admixing of cation and anion reagents, a process of employing the system that injects an admixture of cation and anion reagents or a slurry for the capture of mercury, and the process of sequestering mercury with the systems described herein.

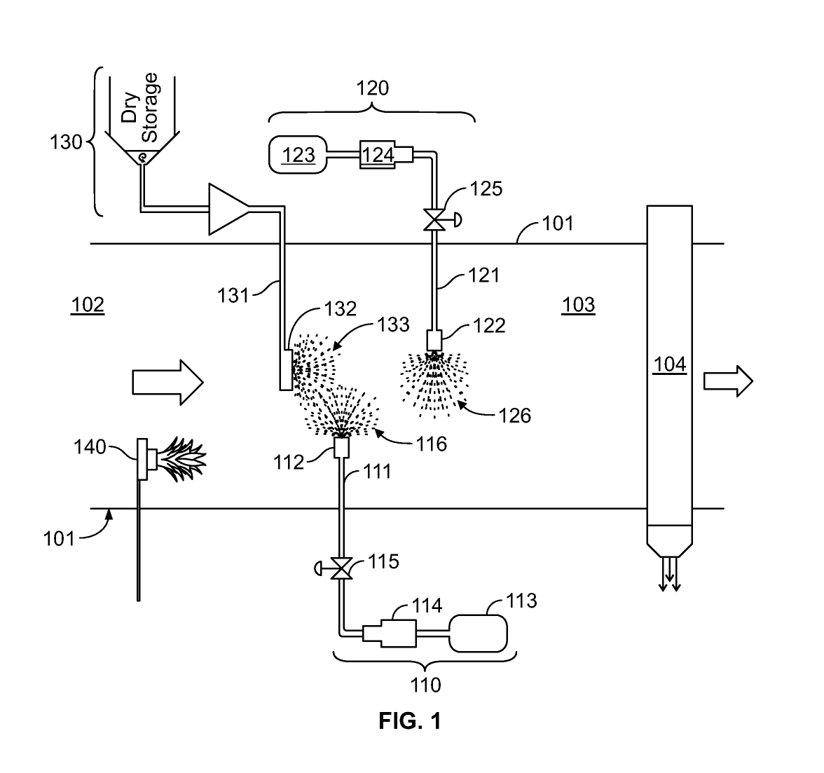

In a first embodiment, a mercury capture system, with reference to FIG. 1, can include a flue gas conduit 101 having an upstream portion 102 and a downstream portion 103 and positioned to carry a flue gas stream produced by a coal-fired boiler. The system can further include a metal solution injection apparatus 110 (or cation injection apparatus) that includes a conduit 111 and a nozzle 112 to produce droplets 116 of a transition metal salt solution and introduce them into the flue gas stream. The system can further include a sulfur injection apparatus 120 (or an anion injection apparatus) that includes a conduit 121 and a nozzle 122 to produce droplets 126 of a sulfide solution and introduce them into the flue gas stream. Preferably, the metal solution injection apparatus 110 and the sulfur injection apparatus 120 are positioned upstream of a particulate collector 104 (e.g., a fly ash particulate collector for example, a bag house or an electrostatic particulate collector (ESP)). Preferably, the metal solution injection apparatus 110 and the sulfur injection apparatus 120 are position upstream of an air heater (not shown).

The mercury capture system can have the metal solution injection apparatus and the sulfur injection apparatus arranged in any one of the following configurations 1) a metal injection nozzle upstream of a sulfur injection nozzle, 2) a sulfur injection nozzle upstream of a metal injection nozzle, 3) a metal injection nozzle and a sulfur injection nozzle coincident in the flue gas stream, or 4) a combination thereof (with a plurality of cation and/or anion nozzles). Notably, the concentration of the transition metal salt solution and the sulfur solution can influence the desirability of one arrangement over another. In one example, the reactive components in the transition metal salt solution are significantly more dilute based on molarity than the reactive components in the sulfur solution; therefore, the metal injection nozzle may be preferably placed upstream of the anion injection nozzle. In one aspect, the positions of the metal solution injection apparatus and the anion injection apparatus are dependent on the relative reactive species in the cation and sulfur solutions. That is, the composition of the respective solutions may affect the preference of the location.

Furthermore, the mercury capture system can include a plurality of metal injection nozzles 112 and/or a plurality of sulfur injection nozzles 122 (the plurality not shown). In one preferable arrangement, the mercury capture system includes at least two metal injection nozzles. That is, the mercury capture system can include a first metal solution injection apparatus and a second metal solution injection apparatus, each having a conduit and nozzle adapted to produce and introduce droplets of the respective transition metal salt solutions into the flue gas stream. More preferably, the mercury capture system includes at least two metal injection apparati that respectively product and introduce different transition metal salt solutions into the flue gas stream, e.g., a first transition metal salt solution and a second transition metal salt solution.

In further detail, a metal solution injection apparatus can include a reservoir of the transition metal salt solution 113 and a pump 114. The pump 114 fluidly connected to the reservoir of the transition metal salt solution 113 and the nozzle 112 and arranged to transport the transition metal salt solution from the reservoir through the conduit 111 to the nozzle 112.

The sulfur injection apparatus can include a reservoir of the sulfur solution 123 and a pump 124. The pump 124 fluidly connected to the reservoir of the sulfur solution 123 and the nozzle 122 and arranged to transport the sulfur solution from the reservoir through the conduit 121 to the nozzle 122.

Preferably, the sulfur solution is a water based solution of a sulfur compound. The sulfur compound can be selected from the group consisting of sodium sulfide, sodium disulfide, sodium sulfide, sodium disulfide, sodium polysulfide, ammonium sulfide, ammonium disulfide, ammonium polysulfide, potassium sulfide, potassium disulfide, potassium polysulfide, calcium polysulfide, sulfur, hydrogen sulfide, hydrogen disulfide, aluminum sulfide, magnesium sulfide, thioacetic acid, thiobenzoic acid, and mixtures thereof. More preferably, the sulfur compound is an alkali metal sulfide (e.g., a sodium sulfide, a potassium sulfide) and/or a alkaline earth sulfide (e.g., a calcium sulfide).

The transition metal salt solution is preferably a water based solution, that is the primary liquid component of the solution is water (e.g., the solution can have a composition that includes 50 to 99 wt. % water, 60 to 90 wt. % water, 70 to 90 wt. % water, or 75 to 85 wt. % water). Preferably, the transition metal salt solution includes a transition metal cation selected from the group consisting of the cations of zinc, copper, nickel, cobalt, iron, and manganese. When a first transition metal salt solution and a second transition metal salt solution are introduced into the flue gas stream, the first transition metal salt solution includes a first transition metal cation selected from the group consisting of the cations of zinc, copper, nickel, cobalt, iron, and manganese and the second transition metal salt solution includes a second transition metal cation selected from the same group. In one preferable example, the first transition metal cation is a copper cation and the second transition metal cation is a cation selected from the group consisting of zinc, iron, and a mixture thereof. In a more preferable example, the first and second transition metal cations are copper and iron, respectively.

In examples where the transition metal salt solution includes a copper cation, the copper cation is derived from the dissolution of a copper salt or copper salt precursor (herein, referred to generally as the copper salt) in the solvent. The copper salt can be selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, and a mixture thereof. Preferably, the copper salt is selected from the group consisting of copper acetate, copper bromide, copper carbonate, copper chloride, copper formate, copper hydroxide, copper nitrate, copper sulfate, and a mixture thereof. Even more preferably, the copper salt is selected from the group consisting of copper acetate, copper bromide, copper carbonate, copper formate, copper sulfate, and a mixture thereof. In one preferable example the copper salt is substantially free of chloride. In another preferable example, the copper salt is a copper bromide or copper carbonate.

In examples where the transition metal salt solution includes an iron cation, the iron cation is derived from the dissolution of an iron salt or iron salt precursor (herein, referred to generally as the iron salt) in the solvent. The iron salt can be selected from the group consisting of iron acetate, iron acetylacetonate, iron bromide, iron carbonate, iron chloride, iron chromate, iron ethylhexanoate, iron formate, iron gluconate, iron hydroxide, iron iodide, iron molybdate, iron nitrate, iron oxide, iron perchlorate, iron pyrophosphate, iron selenide, iron sulfate, iron telluride, iron tetrafluoroborate, iron thiocyanate, iron triflate, and a mixture thereof. In one preferable example the iron salt is substantially free of chloride. In another preferable example, the iron salt is an iron bromide or iron sulfate.

In another preferable example, the mercury capture system includes a sorbent injection apparatus 130 that includes a conduit 131, a nozzle 132, to distribute a sorbent powder 133, and/or an optional flue gas heating apparatus 140. The sorbent injection apparatus can be configured to introduce the sorbent powder 133 into the flue gas stream. The sorbent injection nozzle 132 of the sorbent injection apparatus 130 can be in an arrangement selected from the group consisting of 1) upstream of a metal injection nozzle 112, 2) upstream of a sulfur injection nozzle 122, 3) downstream of a metal solution injection nozzle 112, 4) downstream of a sulfur injection nozzle 122, 5) coincident with a metal solution injection nozzle 112, 6) coincident with a sulfur injection nozzle 122, and 7) a combination thereof. Furthermore, the mercury capture system can include a plurality of sorbent injection nozzles 132 (not shown).

The sorbent powder can be a carbon allotrope, a silicate, an aluminate, or combination thereof. In one example, the sorbent powder can be selected from the group consisting of powdered activated carbon (PAC), vermiculite, montmorillonite, allopohane, talc, fly ash, processed fly ash, and a mixture thereof. In another example, the sorbent powder can be a modified sorbent, that is a sorbent powder wherein the structure or chemistry of the sorbent power has been augmented. Examples of modified sorbents include brominated PAC and silicates or aluminates modified for absorption of mercuric salts. Preferably, the sorbent powder has a very high surface area, that is, a surface area in excess of 250 m²/g, 300 m²/g, 350 m²/g, 400 m²/g, 450 m²/g, or 500 m²/g. The surface area can be in a range of about 250 m²/g to about 1000 m²/g, about 350 m²/g to about 750 m²/g, or 450 m²/g to about 550 m²/g. The surface area is determined by the nitrogen absorption isotherm at 0° C.

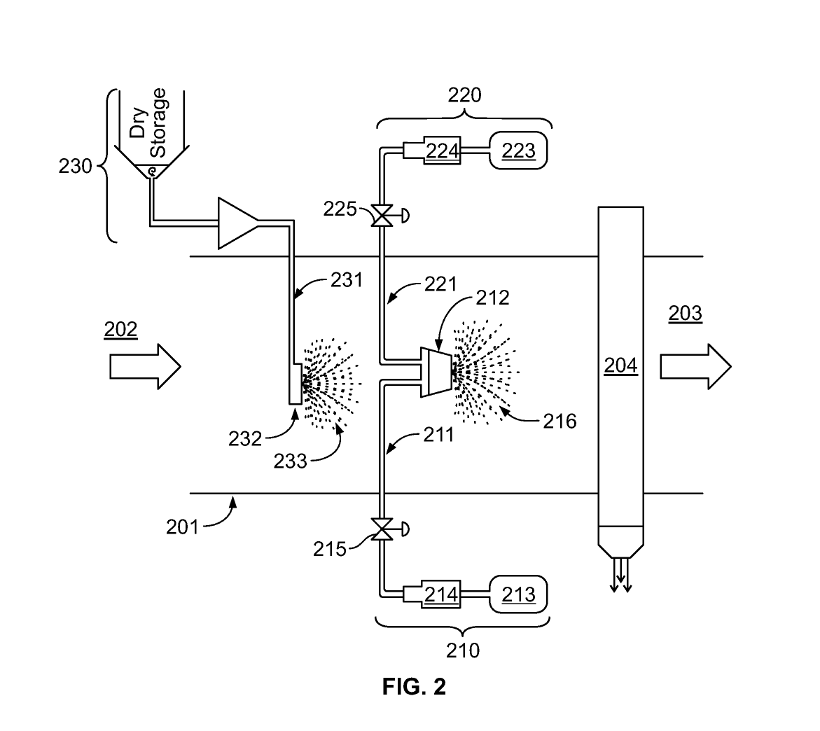

In another embodiment, the mercury capture system, as shown in FIG. 2, can include the flue gas conduit 201 having the upstream portion 202 and the downstream portion 203 and positioned to carry the flue gas stream produced by the coal-fired boiler. This embodiment includes a co-injection nozzle 212 that is configured to produce droplets 216 of an admixture of a transition metal salt solution and a sulfur solution and to introduce these droplets into the flue gas stream. The co-injection nozzle 212 is fed by and fluidly connected to at least one solution conduit 211, preferably at least two solution conduits (e.g., a transition metal salt solution conduit, a first and a second transition metal salt solution conduits, or a conduit for a premixed solution of a plurality of transition metal salts and at least one sulfur solution conduit). The mercury capture system also includes a particulate collector 204, preferably, downstream from the co-injection nozzle 212.

This embodiment can further include a sorbent injection apparatus 230. The sorbent injection apparatus can include a conduit 231 and a nozzle 232 to distribute a sorbent powder 233 in the flue gas. Generally, the sorbent injection apparatus 230 is configured to introduce the sorbent powder 233 into the flue gas stream.

Examples of transition metal salt solutions and sulfur solutions include a stable homogeneous solution of the cations and the anions, an emulsion of a transition metal salt solution and the sulfur solution, separated solutions of cations and anions, slurries of a mercury-sorbent metal sulfide formed by the admixing of the cation and sulfur solutions, and heterogeneous admixture of mercury-sorbent metal sulfides with at least one transition metal salt solution and/or an sulfur solution. In reference to FIG. 2, the reference numbering is indicative to the function of the part and does not differ depending on the respective transition metal salt solutions. In one example, the system includes a first transition metal salt solution delivery apparatus 210 which is fluidly connected to the co-injection nozzle 212. The first transition metal salt solution delivery apparatus 210 can include a first transition metal salt solution conduit 211 that provides the first transition metal salt solution to the co-injection nozzle 212 and is fluidly connected to a first transition metal salt solution pump 214. The first transition metal salt solution pump 214 is fluidly connected to a reservoir of the first transition metal salt solution 213 and is configured to provide the first transition metal salt solution to the co-injection nozzle 212. The system can further include a second transition metal salt solution delivery apparatus 210 which is fluidly connected to the co-injection nozzle 212. The second transition metal salt solution delivery apparatus 210 can include a second transition metal salt solution conduit 211 that provides the second transition metal salt solution to the co-injection nozzle 212 and is fluidly connected to a second transition metal salt solution pump 214. The second transition metal salt solution pump 214 is fluidly connected to a reservoir of the second transition metal salt solution 213 and is configured to provide the second transition metal salt solution to the co-injection nozzle 212.

In another example, the system includes a mixed transition metal salt solution delivery apparatus 210 which is fluidly connected to the co-injection nozzle 212. The mixed transition metal salt solution delivery apparatus 210 can include a mixed transition metal salt solution conduit 211 that provides the mixed transition metal salt solution to the co-injection nozzle 212 and is fluidly connected to a mixed transition metal salt solution pump 214. The mixed transition metal salt solution pump 214 is fluidly connected to a reservoir of the mixed transition metal salt solution 213 and is configured to provide the mixed transition metal salt solution to the co-injection nozzle 212. The mixed transition metal salt solution includes at least a first and a second cation, preferably the first cation is a copper cation and the second cation is selected from the group consisting of zinc, iron, and a mixture thereof.

In another example, the system includes a sulfur solution delivery apparatus 220 which is fluidly connected to the co-injection nozzle 212. The sulfur solution delivery apparatus 220 can include a sulfur solution conduit 221 that provides the sulfur solution to the co-injection nozzle 212 and is fluidly connected to a sulfur solution pump 224. The sulfur solution pump 224 is fluidly connected to a reservoir of the sulfur solution 223 and is configured to provide the sulfur solution to the co-injection nozzle 212. Valving 215 & 225 can be further included in the respective delivery apparati.

When separate solutions of the cation and the anion are included, the mercury capture system can include a mixer fluidly connected to the co-injection nozzle 212 (e.g., by a solution conduit). Furthermore, the mixer is preferably fluidly connected to both the transition metal salt solution conduit and the sulfur solution conduit. Optionally, the mixer and the co-injection nozzle can be a single component.

The above described apparatus can be used to capture and remove mercury from the flue gas produced from a coal fired power plant. Accordingly, another embodiment of the invention is a process of capturing and removing mercury from a flue gas.

In one example, the process includes injecting a plurality of droplets of a transition metal salt solution into a flue gas generated by the combustion of coal in a coal-fired boiler. The process further includes injecting a sulfur solution into the flue gas. Still further, the process includes forming a mercury-sorbent metal sulfide from the transition metal cation and the sulfur anion. Then, the process includes collecting a mercury-metal-sulfide particulate from the flue gas. In another example, the process includes injecting a plurality of droplets of a first transition metal salt solution and a second transition metal salt solution, one of which preferably includes a copper salt, and a sulfur solution, which includes a sulfur compound, into a flue gas generated by the combustion of coal in a coal-fired boiler. Forming a mercury-sorbent metal sulfide from the cations and the sulfur compound and reacting the mercury-sorbent metal sulfide with mercury to form a mercury-metal-sulfide particulate. Then, collecting the mercury-metal-sulfide particulate from the flue gas. In other examples, the plurality of droplets of the transition metal salt solution can include one or more transition metal salts, notably, this plurality of transition metal salts can include, for example, two different transition metals or two different salts of the same transition metal.

The droplets are preferably formed by the pressurized injection of the respective solutions through an injection nozzle. The injection nozzle and pressure selected to provide droplets that individually having a diameter of under 500 μm, under 400 μm, under 300 μm, under 200 μm, under 100 μm, or under 50 μm. Preferably, the droplets have a size distribution at injection or an average size distribution at injection of about 10 μm, 25 μm, 50 μm, 75 μm, 100 μm, or 150 μm. Notably, the droplet size decreases upon addition to the flue gas due in part to evaporation of the solvent.

The injection of the transition metal salt solution and the sulfur solution are, preferably, conducted at a location or locations wherein the solvent carrying the transition metal salt and/or sulfide is rapidly evaporated. For example, the plurality of droplets can be injected into the flue gas at a location where the flue gas has a temperature (i.e., the flue gas at the injection temperature) of at least about 125° C., about 150° C., about 175° C., about 200 ° C., about 250° C., about 300° C., about 350° C., about 400° C., about 450° C., or about 500° C. By way of structural definitions, the plurality of droplets can be injected into the flue gas above or below an air heater, preferably the plurality of droplets are injected above an air heater (i.e., a hot side injection). In examples or embodiments where the flue gas temperature is insufficient to evaporate the solvent in an effective amount of time, the temperature of the flue gas can be increased by the application of a flue gas heating apparatus 140 (e.g., a hot air source or a torch). In other examples or embodiments, the solutions can be heated to temperatures near their boiling points prior to injection or addition to the flue gas, for example, the temperature of the solutions (transition metal salt and/or sulfur) can be heated to about 75° C., 80° C., 85° C., 90° C., 95° C., or 100° C., notably the temperature of the solution can be at or above the boiling point of the solvent due to boiling point elevation effects of the components in the solvent (e.g., salt based boiling point elevation).

In one example, the droplets of the copper solution and the sulfur solution can be injected individually. That is, the process of injecting a plurality of droplets of a copper solution and a sulfur solution includes injecting a plurality of droplets of the copper solution and includes injecting a plurality of droplets of the sulfur solution. This process can be undertaken by including a copper injection apparatus and a, separate, sulfur injection apparatus.

In another example, the injected droplets can be an admixture of the copper solution and the sulfur solution. That is, the process of injecting a plurality of droplets of a copper solution and a sulfur solution includes injecting a plurality of droplets that individually includes both the copper salt and the sulfur compound. This process can be undertaken by including a co-injection nozzle.

In still another example, the droplets of the iron solution and the sulfur solution can be injected individually. That is, the process of injecting a plurality of droplets of an iron solution and a sulfur solution includes injecting a plurality of droplets of the iron solution and includes injecting a plurality of droplets of the sulfur solution. This process can be undertaken by including a copper injection apparatus and a, separate, sulfur injection apparatus.

In yet another example, the injected droplets can be an admixture of the iron solution and the sulfur solution. That is, the process of injecting a plurality of droplets of a iron solution and a sulfur solution includes injecting a plurality of droplets that individually includes both the iron salt and the sulfur compound. This process can be undertaken by including a co-injection nozzle.

In another example, the droplets of a copper solution, an iron solution, and the sulfur solution are injected, individually. That is, the process of injecting a plurality of droplets of a copper solution, an iron solution, and a sulfur solution includes injecting a plurality of droplets of the copper solution, injecting a plurality of droplets of the iron solution, and injecting a plurality of droplets of the sulfur solution. This process can be undertaken by including a copper injection apparatus, an iron injection apparatus and a, separate, sulfur injection apparatus.

In still yet another example, the injected droplets can be an admixture of the copper solution and iron solution; an admixture of the copper solution, iron solution and the sulfur solution; or an admixture of the copper solution and the sulfur solution; or an admixture of the iron solution and the sulfur solution. That is, the process of injecting a plurality of droplets of an admixture can include injecting a plurality of droplets that individually includes both at least two of the copper cation, the iron cation, and the sulfur anion. This process can be undertaken by including a co-injection nozzle.

The formation of the mercury-sorbent metal sulfide can include solution phase reactions, solid phase reactions, or amorphous reactions. In one example, the mercury-sorbent metal sulfide can be formed by admixing a copper solution droplet and a sulfur solution droplet in the flue gas. Within the admixed droplet, the copper salt and the sulfur compound can be reacted, thereby providing the mercury-sorbent metal sulfide supported in a droplet. The process can further include evaporating any volatile components of the droplet (e.g., the solvent), thereby providing a mercury-sorbent metal sulfide particulate (e.g., by evaporating water from the droplet). Other examples include the iron salt and/or both the copper salt and the iron salt.

In another example, the volatile components of the droplets can be evaporated, thereby providing transition metal salt particulates (i.e., particulates that include the transition metal salt, preferably, in an amorphous or poorly crystalline state) and sulfur particulates (i.e., particulates that include the sulfide compound). The process can further include admixing the cation particulates and anion particulates, thereby forming the mercury-sorbent metal sulfide particulate.

In still another example, the volatile components of either the transition metal salt solution or the sulfur solution droplet can be evaporated, thereby providing either transition metal salt particulates or sulfur particulates. The particulates can then be admixed with the remaining droplet to provide the mercury-sorbent metal sulfide in a droplet. The process can further include evaporating any volatile components of the droplet, thereby providing the mercury-sorbent metal sulfide particulate.

The process can further include injecting a sorbent (e.g., a phyllosilicate) into the flue gas. The injected sorbent can be admixed with the droplets of the transition metal salt solution and the sulfur solution in the flue gas, can be admixed with the admixed droplets of the transition metal salt solution and the sulfur solution in the flue gas, can be admixed with the droplets of the mercury-sorbent metal sulfide in the flue gas, and/or can be admixed with the respective particulates. Preferably, the sorbent is admixed with droplets, and then any volatile components are evaporated from the admixture.

In yet another embodiment, the process of capturing and removing mercury from a flue gas can include providing a pressurized flow of a copper solution that includes a copper salt to nozzles that have an outlet within a flue gas conduit, providing a pressurized flow of an iron solution that includes an iron salt to nozzles that have an outlet within a flue gas conduit, and providing a pressurized flow of a sulfur solution that includes a sulfur compound to nozzles that have an outlet within the flue gas conduit. Then producing, in the flue gas conduit carrying a flue gas generated by the combustion of coal, droplets of the copper solution, the iron solution, and the sulfur solution. The droplets individually having a diameter of under 500 μm, under 400 μm, under 300 μm, under 200 μm, under 100 μm, or under 50 μm. The process can further include reacting a mercury-sorbent metal sulfide formed from the copper salt, the iron salt, and the sulfur compound with mercury to form a mercury-metal-sulfide particulate; and then collecting the mercury-metal-sulfide particulate.

In still yet another embodiment, the process of capturing and removing mercury from the flue gas can include providing a pressurized flow of a copper-sulfide slurry to nozzles that have an outlet within a flue gas conduit. The copper-sulfide slurry, preferably, formed by the admixing of a copper solution and a sulfide solution. Then producing, in the flue gas conduit, a plurality of droplets of the copper-sulfide slurry. The process can further include evaporating the solvent from the droplets thereby leaving or producing copper-sulfide particulates. The particulates preferable react with mercury in the flue gas and form a mercury-copper-sulfide particulate that is captured or collected in a particulate collection apparatus (e.g., an ESP or a bag house).

Another feature applicable to the above described embodiments is the concentration or loading of the solutions. Preferably, the solutions are about 3 wt. % to about 25 wt. % reagent (e.g., transition metal salt, sulfur compound, copper-sulfide (in the slurry). More preferably the solutions are about 5 wt. % to about 20 wt. %. Notably, the lower the concentration of the reagent in the solution the higher the concentration (wt. %) of the solvent in the droplets. Accordingly, the lower the concentration of the reagent, the more solvent will need to be removed to produce a particulate. As the removal of the solvent from the droplet is an evaporation process, the removal of the solvent will cool the droplet and/or the flue gas. Therefore, the concentration of the reagent(s) in the droplet can be varied based on the temperature of the flue gas at an injection port. Preferably, the concentration of the reagent in the droplet and the temperature of the flue gas at the injection port are balanced to produce the rapid (less than 5 sec, 4 sec, 3 sec, 2 sec, or 1 sec) evaporation of the solvent. In embodiments where the transition metal salt and the sulfur reagents are injected into the flue gas a separate, discrete droplets, the concentrations can be adjusted to provide, for example, droplet-droplet interaction, particulate-droplet interaction, or particulate-particulate interactions. In one preferably embodiment, the concentrations, temperatures, and injection locations are chosen to provide droplet-droplet interactions prior to the complete removal of the solvent(s) (herein, the term complete removal is used as opposed to removal because the evaporation of the solvent begins immediately upon injection into the flue gas). Furthermore, the interaction of the reagents with the sorbent powder (e.g., clay) can be droplet to sorbent powder or solid to sorbent powder. Preferably, the droplets admix with the sorbent powder (e.g., wet the sorbent powder) prior to the evaporation of all of the solvent.

Yet another feature applicable to the above described embodiments is the selection of the injection nozzles. Preferably, the injection nozzles are twin-fluid atomizers that deliver a gas and a liquid to the flue gas. These twin-fluid atomizers preferably deliver the transition metal salt solution, the sulfur solution, an admixture of the transition metal salt solution and the sulfur solution, and/or a slurry of the reaction product of the transition metal salt solution and the sulfur solution.

1. A mercury capture system that comprises:
a flue gas conduit having an upstream portion and a downstream portion and positioned to carry a gas stream produced by a coal-fired boiler;
a metal solution injection apparatus, that includes a conduit and a nozzle, adapted to produce droplets of a transition metal salt solution and introduce them into the gas stream;
a sulfur injection apparatus, that includes a conduit and a nozzle, adapted to produce droplets of a sulfur solution and introduce them into the flue gas stream; and
a particulate collector.

2. The mercury capture system of claim 1, wherein the metal solution injection apparatus and the sulfur injection apparatus are arranged in one of the following configurations 1) the metal solution injection nozzle is upstream of the sulfur injection nozzle, 2) the sulfur injection nozzle is upstream of the metal solution injection nozzle, or 3) the metal solution injection nozzle and the sulfur injection nozzle are coincident in the flue gas stream.

3. The mercury capture system of claim 1, wherein the metal solution injection apparatus includes a reservoir of the transition metal salt solution and a pump fluidly connected to the reservoir of the transition metal salt solution and the nozzle; the pump arranged to transport the transition metal salt solution from the reservoir through the conduit to the nozzle.

4. The mercury capture system of claim 1, wherein the sulfur injection apparatus includes a reservoir of the sulfur solution and a pump fluidly connected to the reservoir of the sulfur solution and the nozzle;
the pump arranged to transport the sulfur solution from the reservoir through the conduit to the nozzle.

5. The mercury capture system of claim 1, further comprising:
a sorbent injection apparatus that includes a conduit and a nozzle to distribute a sorbent powder; the sorbent injection apparatus configured to introduce the sorbent powder into the flue gas stream.

6. The mercury capture system of claim 5, wherein the absorbent injection nozzle of the sorbent injection apparatus is in an arrangement selected from the group consisting of 1) upstream of the metal solution injection nozzle, 2) upstream of the sulfur injection nozzle, 3) downstream of the metal solution injection nozzle, 4) downstream of the sulfur injection nozzle, 5) coincident with the metal solution injection nozzle, 6) coincident with the sulfur injection nozzle, and 7) a combination thereof.

7. The mercury capture system of claim 5 further comprising a plurality of sorbent injection nozzles.

8. The mercury capture system of claim 5, wherein the sorbent powder is a silicate, aluminate, activated carbon, or combination thereof.

9. The mercury capture system of claim 5, wherein the sorbent powder is selected from the group consisting of vermiculite, montmorillonite, allopohane, talc, fly ash, processed fly ash, and a mixture thereof.

10. A mercury capture system that comprises:
a flue gas conduit having an upstream portion and a downstream portion and positioned to carry a flue gas stream produced by a coal-fired boiler;
a co-injection nozzle configured to produce droplets of an admixture of a transition metal salt solution and a sulfur solution and to introduce the droplets into the flue gas stream, the co-injection nozzle fluidly connected to at least one solution conduit; and
a particulate collector.

11. The mercury capture system of claim 10 further comprising:
a sorbent injection apparatus that includes a conduit and a nozzle to distribute a sorbent powder, the sorbent injection apparatus configured to introduce the sorbent powder into the flue gas stream.

12. The mercury capture system of claim 10 further comprising:
a transition metal salt solution conduit and a sulfur solution conduit;
the transition metal salt solution conduit fluidly connected to a transition metal salt solution pump that is fluidly connected to a reservoir of the transition metal salt solution;
the sulfur solution conduit fluidly connected to a sulfur solution pump that is fluidly connected to a reservoir of the sulfur solution.

13. The mercury capture system of claim 12 further comprising a mixer fluidly connected to the co-injection nozzle, the transition metal salt solution conduit, and the sulfur solution conduit.

14. A process of capturing and removing mercury from a flue gas comprising:
injecting into a flue gas generated by the combustion of coal in a coal-fired boiler either:
a plurality of droplets of a transition metal cation solution that includes a transition metal salt and a plurality of droplets of a sulfur solution that includes a sulfur compound, or
a plurality of droplets of an admixture of the transition metal salt solution and the sulfur solution;
forming a mercury-sorbent sulfide from the transition metal salt and the sulfur compound;
reacting the mercury-sorbent sulfide with mercury to form a mercury-metal-sulfide particulate; and
collecting the mercury-metal-sulfide particulate from the flue gas.

15. The process of claim 14, wherein injecting the plurality of droplets into the flue gas includes the flue gas at an injection temperature of at least about 125° C., about 150° C., about 175° C., about 200° C., about 225° C., about 250° C., about 275° C., or about 300° C.

16. The process of claim 14, wherein the plurality of droplets are injected into the flue gas upstream of an air heater.

17. The process of claim 14, wherein the transition metal salt solution includes a transition metal salt selected from the group consisting of a copper salt, an iron salt, and a mixture thereof; preferably the copper salt is selected from the group consisting of copper acetate, copper acetylacetonate, copper bromide, copper carbonate, copper chloride, copper chromate, copper ethylhexanoate, copper formate, copper gluconate, copper hydroxide, copper iodide, copper molybdate, copper nitrate, copper oxide, copper perchlorate, copper pyrophosphate, copper selenide, copper sulfate, copper telluride, copper tetrafluoroborate, copper thiocyanate, copper triflate, and a mixture thereof; preferably the iron salt is selected from the group consisting of iron acetate, iron acetylacetonate, iron bromide, iron carbonate, iron chloride, iron chromate, iron ethylhexanoate, iron formate, iron gluconate, iron hydroxide, iron iodide, iron molybdate, iron nitrate, iron oxide, iron perchlorate, iron pyrophosphate, iron selenide, iron sulfate, iron telluride, iron tetrafluoroborate, iron thiocyanate, iron triflate, and a mixture thereof; more preferably the transition metal salt solution is substantially free of a chloride.

18. The process of claim 14, wherein the sulfur solution comprises a sulfur compound selected from the group consisting of sodium sulfide, sodium disulfide, sodium sulfide, sodium disulfide, sodium polysulfide, ammonium sulfide, ammonium disulfide, ammonium polysulfide, potassium sulfide, potassium disulfide, potassium polysulfide, calcium polysulfide, sulfur, hydrogen sulfide, hydrogen disulfide, aluminum sulfide, magnesium sulfide, thioacetic acid, thiobenzoic acid, and mixtures thereof.

19. The process of claim 14 further comprising
evaporating a volatile component of the droplet that includes an admixture of the transition metal salt solution and the sulfur solution thereby providing a mercury-sorbent sulfide particulate.

20. The process of claim 14 further comprising:
evaporating a volatile component of the droplets that include the transition metal salt solution and the droplets that include the sulfide solution thereby providing particulates that include the transition metal salt and particulates that include the sulfur compound.

21. The process of claim 14 further comprising:
injecting a sorbent into the flue gas; and
admixing the sorbent and the mercury-sorbent sulfide.

22. The process of claim 14, wherein droplets, individually, have an average diameters of under 500 μm, under 400 μm, 300 μm, 200 μm, 100 μm, or 50 μm.

23. A process of capturing and removing mercury from a flue gas comprising:
injecting into a flue gas generated by the combustion of coal in a coal-fired boiler a plurality of droplets of a solution that carries a mercury-sorbent sulfide and a solvent;
reacting the mercury-sorbent sulfide with mercury to form a mercury-metal-sulfide particulate; and
collecting the mercury-metal-sulfide particulate from the flue gas.
